(19) United States
(12) Patent Application Publication
(10) Pub. No.: US 2010/0045696 A1
(43) Pub. Date: Feb. 25, 2010

(54) Method for producing 2D image slices from 3D projection data acquired by means of a CT system from an examination subject containing metal parts

(75) Inventors: Hebert Bruder, Melsenstr (DE); Rainer Raupach, Heroldsbach (DE)

Correspondence Address: HARNESS, DICKEY & PIERCE, P.L.C., P.O. BOX 8910, RESTON, VA, 20195, US

(73) Assignee: Siemens Aktiengesellschaft

(21) Appl. No.: 12/461,611

(22) Filed: Aug. 18, 2009

(30) Foreign Application Priority Data
Aug. 19, 2008 (DE) 10 2008 038 357.0

(51) Int. Cl. G09G 5/00

(52) U.S. Cl. 345/611; 345/630; 382/131

(57) ABSTRACT

A method of at least one embodiment has three method sections. In the first method section, 3D projection data is generated by 3D scanning of the examination subject and first 3D image data is reconstructed therefrom by means of convolution back projection. In the second method section, the image artifacts present in the first 3D image data because of the metal parts are corrected via simple correction methods which produce at least a coarse reduction in the image artifacts involving a low degree of computational complexity. In the third method section, 2D image data is selected from the corrected 3D image data and made available. For image artifacts still contained in the 2D image data, more complex correction methods than in the second method section are used which permit effective elimination of the image artifacts.

### PRIORITY STATEMENT

The present application hereby claims priority under 35 U.S.C. §119 on German patent application number DE 10 2008 038 357.0 filed Aug. 19, 2008, the entire contents of which are hereby incorporated herein by reference.

### FIELD

At least one embodiment of the invention generally relates to a method for producing image slices from 3D projection data acquired by way of a CT system from an examination subject containing metal parts.

### BACKGROUND

It is well known that projection data acquired using a CT system from an examination subject having metal parts, such as metal artificial joints or metal-containing implants, result in ray-like image artifacts emanating from the metal parts during subsequent reconstruction of image slices (2D image slice data). Such image artifacts are caused by the non-locality of the convolution kernel on which the convolution back projection is based, whereby X-rays penetrating the metal parts in the examination subject contribute to image formation even in metal-free regions. This causes image artifacts in the reconstructed 2D image data which make reliable diagnosis impossible in the immediate vicinity of the metal parts.

FIG. 1 shows such an image slice of a patient in which a metal structure inside the patient, here a metal femoral head prosthesis, results in severe image artifacts radiating from the metal structure and in the direction of the scanning radiation.

In order to correct metal artifacts of this kind when producing image slices, correction methods are known which, however, because they are applied to 3D projection data, require an extremely high degree of computational complexity.

### SUMMARY

In at least one embodiment of the present invention, a method is disclosed for generating and displaying image slices from 3D projection data acquired by way of a CT system from an examination subject containing metal parts, the method requiring comparatively low computational complexity while producing the same image slice quality as prior art methods.

In at least one embodiment, the inventors propose a method comprising:
1.1. 3D scanning of the examination subject along a system axis of a CT system by at least one X-ray detector system, 3D projection data being acquired from a large number of projection angles by rotating the X-ray detector system about the system axis,
1.2. reconstructing first 3D image data on the basis of the 3D projection data acquired,
1.3. segmenting the first 3D image data to produce second 3D image data, said second 3D image data containing only the 3D image data representing metal parts of the examination subject,
1.4. determining the 3D projection data affected by metal components in the examination subject during 3D scanning,
1.5. replacing the 3D projection data determined in step 1.4. by 3D replacement data, said 3D replacement data being obtained from the 3D projection data not affected by the metal parts by simple interpolation,
1.6. reconstructing third 3D image data on the basis of the 3D projection data containing the 3D replacement data,
1.7. generating fourth 3D image data from the third and second 3D image data, said second 3D image data being substituted into the third 3D image data,
1.8. generating first 2D image data from the fourth 3D image data,
1.9. segmenting the first 2D image data to produce second 2D image data, said second 2D image data containing only first 2D image data representing the metal parts of the examination subject,
1.10. reprojecting the first 2D image data to produce 2D reprojection data,
1.11. determining the 2D reprojection data affected by metal parts in the examination subject,
1.12. replacing the 2D reprojection data determined in step 1.11. by 2D replacement data, said 2D replacement data being obtained using a more complex replacement method relative to the interpolation in step 1.5. from the generated 2D reprojection data not affected by metal parts in the examination subject,
1.13. reconstructing third 2D image data on the basis of the 2D reprojection data containing the 2D replacement data,
1.14. generating an image slice from the third and second 2D image data, said second 2D image data being substituted into the third 2D image data, and
1.15. displaying the image slice on a display means.

The method according to at least one embodiment of the invention is essentially based on three method sections. In the first method section (steps 1.1-1.2.), 3D projection data is generated by 3D scanning of the examination subject containing the metal parts and first 3D image data is reconstructed by means of known convolution back projection. The first 3D image data therefore contains the above described metal-part-induced image artifacts to be eliminated.

The image artifacts are eliminated in the other two method sections. In the second method section (steps 1.3.-1.7.), the image artifacts contained in the first 3D image data are corrected by way of simple correction methods involving low computational complexity and resulting in at least coarse reduction in the image artifacts. The application of this first image artifact correction results in the generation of the fourth 3D image data.

On the basis of the fourth 3D image data in which the metal artifacts are at least coarsely corrected, in the third method section (steps 1.8.-1.14.) an image data layer with predefinable layer thickness is first selected from the fourth 3D image data and made available as 2D image data, the fourth 3D image data being advantageously provided as a stack of 2D image data layers. The first 2D image data can therefore be generated, for example, by selecting an individual 2D image data layer from the stack. It may also be intended to combine a volume consisting of a plurality of coordinate 2D image data layers in the 3D image data, i.e. a 2D image data layer with predefinable layer thickness, to produce 2D image data. In this case a plurality of coordinate 2D image data layers are selected in the fourth 3D image data and then allocated to the 2D image data.

Further image artifact correction is performed for the 2D image data originating from the fourth 3D image data, more complex correction methods than in the second method section being applied here which permit effective removal of the image artifacts in the 2D image data. In step 1.14., as the result of said second image artifact correction, the image slice is produced which is displayed in step 1.15. on a display means, e.g. a monitor.

By way of the inventive iterative reconstruction and display of an image slice (steps 1.1.-1.15) in which a coarse first image artifact correction is performed for the first 3D image data and a more complex and sophisticated second image artifact correction is performed for the 2D image data selected from the corrected fourth 3D image data, the computational complexity can be significantly reduced compared to the known correction methods.

Specifically, 3D scanning of the examination subject is performed in step 1.1 using a known prior art CT system. Two examples of such CT systems will be described below.

In step 1.2, the 3D projection data acquired using the CT system is reconstructed by way of a known reconstruction method, i.e. using convolution back projection, to produce the first 3D image data.

In step 1.3., the first 3D image data is segmented to generate second 3D image data, the second 3D image data containing only the first 3D image data representing the metal parts of the examination subject. In this description, segmentation is to be understood as meaning an assignment of data to predefined segments or more specifically data classes. In the present case, segmentation is therefore used to assign all the first 3D image data representing metal parts to the second 3D image data, which can be achieved e.g. by thresholding. The second 3D image data therefore represents a 3D image only of the metal parts of the examination subject.

In step 1.4., the 3D projection data affected by metal parts in the examination subject during 3D scanning is determined. This can be done by applying known thresholding techniques to the 3D projection data. It is also conceivable for the above mentioned 3D projection data to be determined by reprojection of the second 3D image data, wherein the reprojection of image data to produce reprojection data corresponds to an inversion of the reconstruction of the image data from projection data.

In step 1.5., the 3D projection data determined in step 1.4. is replaced by 3D replacement data, said 3D replacement data being obtained by way of simple interpolation from the 3D projection data which was not affected by metal parts. The 3D replacement data is advantageously obtained by means of interpolation between 3D projection data not affected by metal parts which is adjacent to the 3D projection data to be replaced. For this purpose, the 3D projection data is advantageously provided as a 3D sinogram, in particular as a 3D sinogram in parallel geometry. In a simple embodiment, row-wise interpolation in the 3D sinogram is performed.

In a variant of the method, in step 1.5. the first and second 3D image data is reprojected and provided as 3D sinograms in each case. From the 3D sinograms provided, a 3D difference sinogram is generated in which the metal region is cut out. FIG. 2 show a sub-region of such a 3D difference sinogram, wherein the black track represents all the removed 3D projection data affected by metal parts in the examination subject. The replacement of the removed 3D projection data is performed by interpolation, preferably row-wise interpolation, between the projection data present outside the black track.

After step 1.5. has been carried out, all the 3D projection data affected by metal parts is replaced by 3D replacement data. The 3D projection data containing the 3D replacement data therefore represents semi-synthetic 3D projection data of the examination subject without metal parts.

Due to the use of simple interpolation methods for determining the 3D replacement data in step 1.5., the computational complexity involved is comparatively low. The more complex the interpolation methods used here, the higher the resulting quality of the 3D completion data, but the greater the computational complexity involved.

In step 1.6., third 3D image data is reconstructed on the basis of the 3D projection data containing the 3D replacement data. The third 3D image data therefore represents a 3D image of the examination subject without metal parts.

In step 1.7., fourth 3D image data is generated from the third and second 3D image data, said second 3D image data being substituted into the third 3D image data. This means that the metal image voxels of the second 3D image data segmented in step 1.3. are inserted into the third 3D image data so that the fourth 3D image data represents the examination subject with metal parts. In the fourth 3D image data, the image artifacts are already significantly reduced compared to the first 3D image data.

In step 1.8., first 2D image data is generated from the fourth 3D image data. Reference is made at this juncture to the explanations given above.

In step 1.9., the first 2D image data is segmented to produce second 2D image data, said second 2D image data containing only the first 2D image data representing metal parts of the examination subject. As this segmentation step corresponds to step 1.3. with the difference that this time 2D image data is segmented, reference is made to the comments relating to step 1.3.

In step 1.10., the first 2D image data is reprojected to produce 2D reprojection data.

In step 1.11., analogously to step 1.4., the 2D reprojection data affected by metal parts in the examination subject is determined, so that reference is made to the explanations relating to step 1.4.

In step 1.12., the 2D reprojection data determined in step 1.11. is replaced by 2D replacement data, the 2D replacement data being obtained, by means of a more complex replacement method relative to the interpolation of step 1.5., from the generated 2D reprojection data not affected by metal parts in the examination subject.

In a particularly advantageous manner, the 2D replacement data is obtained by:
providing the 2D reprojection data as a 2D sinogram, in particular as a 2D sinogram in parallel geometry wherein, after reprojection, each pixel of the first 2D image data forms a 2D track in the 2D sinogram,
obtaining the 2D tracks in the 2D sinogram which were formed by reprojection of pixels of the first 2D image data representing no metal parts, and which intersect the at least one 2D track formed by the 2D reprojection data determined in step 1.11. at least at one intersection point in the 2D sinogram,
determining a minimum reprojection value on each previously determined 2D track, and
obtaining the 2D replacement data by adding up all the minimum 2D reprojection values of all the 2D tracks obtained for the respective intersection points in the 2D sinogram.

This replacement algorithm uses the basic concept of sinogram decomposition and completion as described, for example, in R. Chityala, K. R. Hoffmann, S. Rudin, D. R. Bednarek, “Artifact reduction in truncated CT using Sinogram completion”, Proceedings of SPIE, Medical Imaging, Vol. 5747, 2005, pp. 1605, the entire contents of which is incorporated herein by reference into the disclosure content of the present description. In the case described here, the algorithm is applied to 2D CT projection data wherein metal artifacts are corrected.

The 3D and/or 2D replacement data obtained is advantageously smoothed. Particularly advantageously, smoothing of the 3D replacement data is performed at least also compared to the unreplaced 3D projection data, and/or smoothing of the 2D replacement data is performed at least also compared to the unreplaced 2D reprojection data. In a variant of the method, smoothing is performed in the 3D/2D sinogram by averaging in the boundary region between 3D/2D replacement data and the unreplaced 3D projection data/2D reprojection data.

In step 1.13., third 2D image data is reconstructed on the basis of the 2D reprojection data containing the 2D replacement data. The third 2D image data therefore represents a 2D image of the examination subject without metal parts.

In step 1.14., the image slice is generated from the third and second 2D image data, said second 2D image data being substituted into the third 2D image data. The metal image voxels of the second 2D image data segmented in step 1.9. are therefore inserted into the third 2D image data so that the image slice represents the examination subject with metal parts, the image artifacts being at least almost completely removed. Finally, in step 1.15, the image slice is displayed on a display device.

To display further image-artifact-corrected image slices from the fourth 3D image data, the method can be repeated after step 1.15., beginning with step 1.9.

The 3D projection data and 2D reprojection data can be provided as a 3D and 2D sinogram respectively, particularly as, respectively, a 3D and 2D sinogram in parallel geometry.

The method described allows the generation and display of image slices from 3D projection data acquired by way of a CT system from an examination subject containing metal parts, the quality of the reconstructed 2D image slices being the same as in the prior art, but with a comparatively lower computational complexity.

### BRIEF DESCRIPTION OF THE DRAWINGS

By way of example, the present method will now be explained once again with reference to the following example embodiments without limitation of the scope of protection specified by the claims, and in conjunction with the accompanying drawings in which:

FIG. 1 shows an axial CT image of a patient with a metal femoral head prosthesis (prior art)

FIG. 2 shows a sub-region of a 3D sinogram in which the sinogram tracks assigned to the metal parts are eliminated

FIG. 3 shows, in order to define the scanning geometry, a schematic image slice through a patient with a metal structure

FIG. 4 is a flow chart showing the sequence of a method according to an embodiment of the invention

FIG. 5 shows a CT system

FIG. 6 shows a C-arm system

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

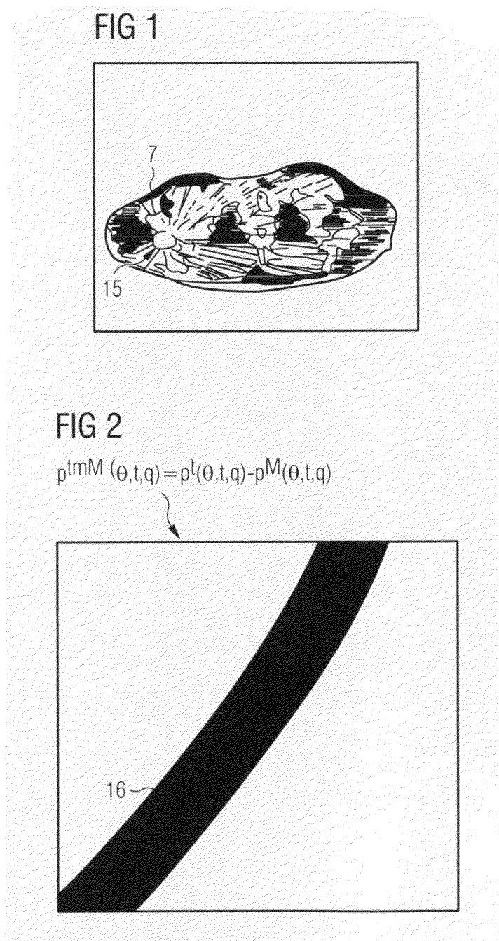

FIG. 1 shows a CT image slice through a patient 7 with a metal femoral head prosthesis 15. The CT image slice was obtained using convolution back projections from acquired CT projection data and has image artifacts radiating out from the metal structure. The method according to an embodiment of the invention is designed to prevent such image artifacts.

A first embodiment of the method according to an embodiment of the invention comprises the following steps:

Method Section 1:
3D scanning of the examination subject along a system axis of a CT system by at least one X-ray detector system, 3D projection data being obtained from a large number of projection angles by rotating the X-ray detector system about the system axis, and providing the projection data as a 3D parallel sinogram p′ (θ,t,q), wherein (θ,t,q) denote the parallel coordinates.
reconstructing first 3D image data on the basis of the 3D projection data acquired.
segmenting the first 3D image data by way of thresholding to produce second 3D image data, said second 3D image data containing only the first 3D image data representing the metal parts of the examination subject.

Method Section 2:
determining the 3D projection data affected by metal parts in the examination subject during 3D scanning by reprojecting the second 3D image data to produce 3D reprojection data and providing the 3D reprojection data as a 3D parallel sinogram p^{M} (θ,t,q) determined by the metal structure alone.
replacing the previously determined 3D projection data by 3D replacement data, said 3D replacement data being obtained by means of simple interpolation from 3D projection data not affected by the metal parts.

For this purpose, the 3D parallel sinograms p′ (θ,t,q) and p^{M} (θ,t,q) are subtracted from one another, thereby producing the 3D difference sinogram p^{tmM} (θ,t,q)=p′ (θ,t,q)−p^{M} (θ,t,q) in which the metal region is cut out. FIG. 2 shows a sub-region of such a 3D difference sinogram p^{tmM} (θ,t,q). The cut-out sinogram data in the 3D difference sinogram is replaced by means of row-wise interpolation of the metal gaps.
reconstructing third 3D image data on the basis of the 3D difference sinogram data containing the 3D replacement data.
generating fourth 3D image data from the third and second 3D image data, said second 3D image data being substituted into the third 3D image data.

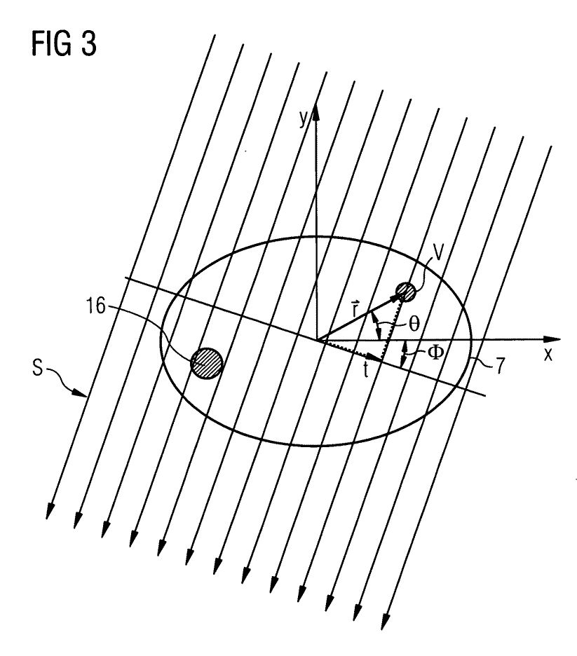

Method Section 3:
generating first 2D image data from the fourth 3D image data by selecting coordinate image data layers of the fourth 3D image data with selectable layer thickness and possibly allocating it to first 2D image data.
reprojecting the first 2D image data to produce 2D reprojection data which is provided as a 2D parallel sinogram, a voxel with the polar coordinates (r,Φ) (cf. FIG. 3) defining a track in the 2D parallel sinogram. With

t(r,θ,Φ)=r·cos(θ+Φ) and y(r,θ,Φ)32 r·sin(θ+Φ)

this track is unambiguously defined in the 2D parallel sinogram.

To make the above geometry clear, FIG. 3 shows a section through a patient 7 with a metal structure M in the Cartesian (x,y,z) coordinate system likewise represented in relation to the cylindrical coordinates and parallel coordinates, the z-axis (not visible) being perpendicular to the image plane. The rays S disposed in a parallel manner correspond to the parallel sorted rays of a projection after parallel rebinning.
decomposition and completion of the 2D parallel sinogram, all the voxels outside a segmented region being considered, whereby the metal region can either be segmented and reprojected in the image layer considered, i.e. the first 2D image data (analogously to the segmentation of the first 3D image data), or, alternatively, raw data based segmentation is also conceivable by identifying the tracks in the sinogram whose sum integral exceeds a defined limit value.

The replacing of the reprojection data affected by metal parts in the examination subject takes place by continuation of the 2D tracks in the cut-out data region of the 2D parallel sinogram p^{M} (θ,t) as follows:

\hat{p}(r,Φ)=min_{(t,θ)}(t(r,θ,φ))·I_{θ}(t)
with

$${I}_{θ} ( t ) = \{ \begin{matrix}1 & ∀ t = r \cdot cos ( θ + Φ ) \\ 0 & sonst\end{matrix}$$

The minimum found along the 2D track is therefore entered in the cut-out data region of the 2D parallel sinogram. The basic concept is that a 5 object in the pixel (r, Φ) in the 2D parallel sinogram would produce precisely this signal in the cut-out region.

If signal tracks in the 2D parallel sinogram intersect, the sum of the signals of the individual paths is entered at the relevant intersection points. At the edges of the cut-out data region, matching of the signal level to the unreplaced reprojection data is necessary. This can be done, for example, by determining the signal levels in and outside the replaced data in a track by averaging in a sub-region, and eliminating discontinuities at the edge of the cut-out data region by appropriate scaling of the projection data. Mixing of the ‘minimum’ signal and the actual signal at the edge of the cut-out data region inside a track is helpful in order to eliminate discontinuities.
reconstructing a 2D image slice from the 2D parallel sinogram data containing the replacement data and displaying the 2D image slice on a display device.

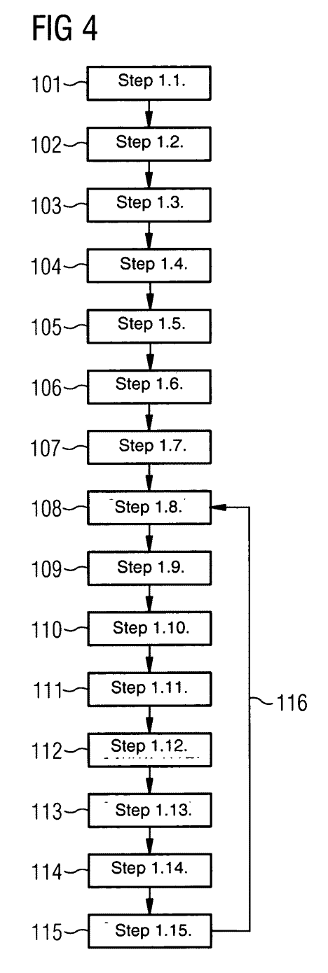

FIG. 4 shows a second variant of the method according to an embodiment of the invention, comprising the following steps:
Step 1.1. (101): 3D scanning of the examination subject along a system axis of a CT system by at least one X-ray detector system, wherein 3D projection data is acquired by rotating the X-ray detector system about the system axis from a large number of projection angles.
Step 1.2. (102): reconstructing first 3D image data on the basis of the 3D projection data acquired.
Step 1.3. (103): segmenting the first 3D image data to produce second 3D image data, said second 3D image data containing only the first 3D image data representing the metal parts of the examination subject.
Step 1.4. (104): determining the 3D projection data affected by metal parts in the examination subject during 3D scanning.
Step 1.5. (105): replacing the 3D projection data determined in step 1.4. by 3D replacement data, said 3D replacement data being obtained by means of simple interpolation from the 3D projection data not affected by metal parts.
Step 1.6. (106): reconstructing third 3D image data on the basis of the 3D projection data containing the 3D replacement data.
Step 1.7. (107): generating fourth 3D image data from the third and second 3D image data, said second 3D image data being substituted into the third 3D image data.
Step 1.8. (108): generating first 2D image data from the fourth 3D image data.
Step 1.9. (109): segmenting the first 2D image data to produce second 2D image data, said second 2D image data containing only the first 2D image data representing metal parts of the examination subject.
Step 1.10. (110): reprojecting the first 2D image data to produce 2D reprojection data.
Step 1.11. (111): determining the 2D reprojection data affected by metal parts in the examination subject.
Step 1.12. (112): replacing the 2D reprojection data determined in step 1.11. by 2D replacement data, the 2D replacement data being obtained by means of a more complex replacement method relative to the interpolation of step 1.5. from the generated 2D reprojection data not affected by metal parts in the examination subject.
Step 1.13. (113): reconstructing third 2D image data on the basis of the 2D reprojection data containing the 2D replacement data.
Step 1.14. (114): generating a 2D image slice from the third and second 2D image data, said second 2D image data being substituted into the third 2D image data.
Step 1.15. (115): displaying the 2D image slice on a display means.
Repetition of the method after step 1.15. beginning with step 1.8.

The 3D scanning is performed according to an embodiment of the inventive method by way of a CT system. Two typical CT systems will be briefly explained below.

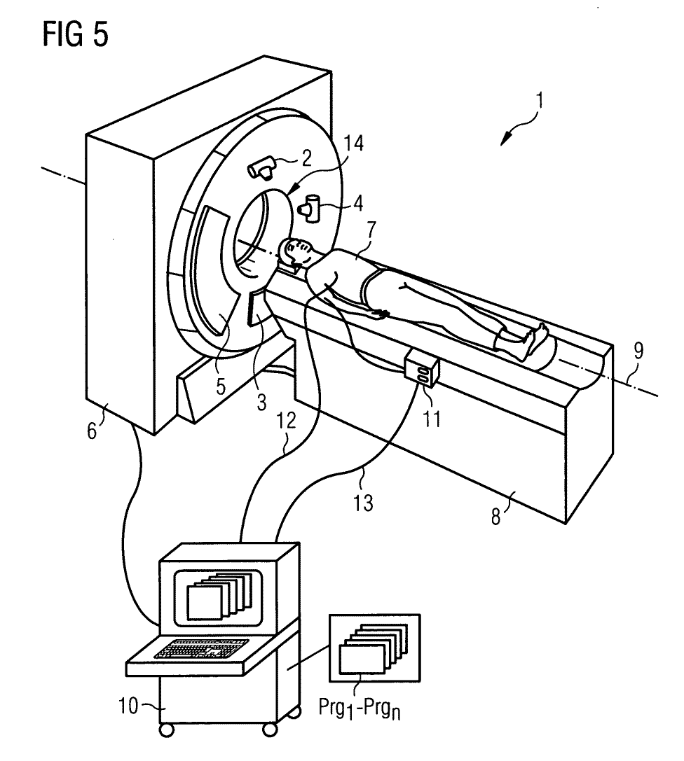

FIG. 5 shows a gantry-mounted CT system 1 having a first tube/detector system comprising an X-ray tube 2 and a detector 3 disposed opposite thereto in a gantry housing 6. Also shown as an option is a second tube/detector system consisting of an X-ray tube 4 and an oppositely disposed detector 5, which system can be used for faster scanning in the same energy range as that of the first tube/detector system, e.g. as part of a cardio examination, or alternatively in the context of dual-energy scanning for scanning with a different X-ray energy. In this example, the tube/detector systems are disposed with an angular offset of 90° in respect of their center beam. On the movable patient couch 8 is a patient 7 who can be administered a contrast agent by means of a contrast agent applicator 11, controlled by a control cable 13 via the control and arithmetic unit 10.

The patient 7 is slid along the system axis 9 through an aperture 14 in the gantry housing 6 while the tube/detector systems scan the patient 7 in a rotating manner. The 3D scanning can take place here in the form of helical scanning or also in the form of sequential circular scanning. Also shown as an option in FIG. 5 is an ECG cable 12 which likewise leads to the control and arithmetic unit 10, making it possible to perform gated scanning of the patient. The control and arithmetic unit 10 otherwise also controls the operation of the CT system 1 as a whole, using computer programs Prg₁ to Prgₙ. Said computer programs Prg₁ to Prgₙ can also contain a computer program which executes the method according to an embodiment of the invention directly on the CT system.

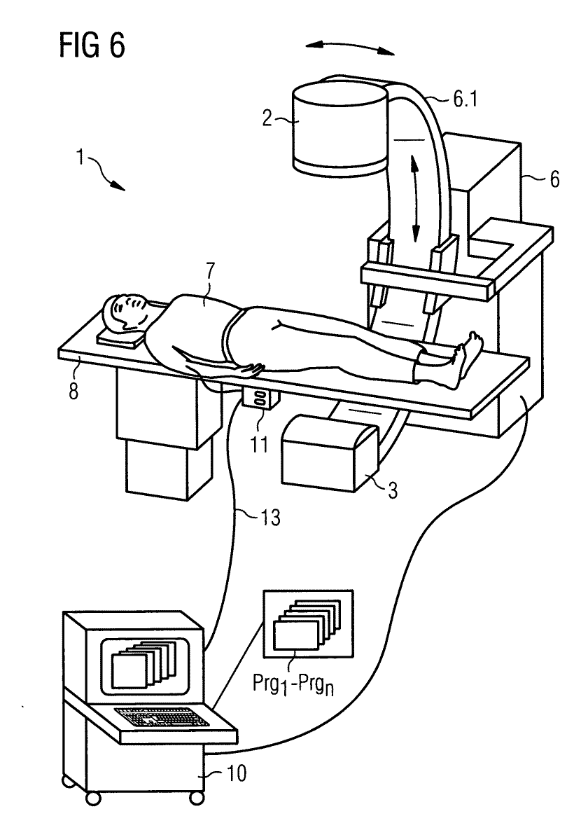

The method according to an embodiment of the invention can also be used in the context of CT examinations in conjunction with C-arm systems, as shown in FIG. 6. This C-arm system 1 has a tube/detector system wherein the X-ray tube 2 and the detector 3 opposite thereto is disposed on a C-arm 6.1 of a C-arm drive system 6. By appropriate rotation of the C-arm 6.1, the patient 7 on a patient couch 8 is scanned similarly to a CT system in a circular manner through a rotation angle of at least 180°, so that computed tomographic representations can be reconstructed from the projection data obtained. Before or during scanning, the patient 7 can be administered contrast agent by means of a contrast agent applicator 11 for better representation of vessels.

The C-arm drive system 6 is controlled by a control and arithmetic unit 10 via a control and data cable 12. In addition, the contrast agent applicator 11 can also be triggered by the control and arithmetic unit 10 via a control cable 13. In addition to the control programs, the programs Prg₁-Prgₙ of the control and arithmetic unit 10 also include programs for analyzing received data from the detector 3 and programs for reconstructing and displaying the CT image data, including the correction methods according to an embodiment of the invention.

However, attention is drawn to the fact that the method according to an embodiment of the invention can also be executed in conjunction with standalone computing systems as soon as said computing systems receive at least projection data from a CT system or C-arm system.

The above mentioned features of embodiments of the invention can obviously be used not only in the combination specified but also in other combinations or in isolation without departing from the scope of the invention.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for generating and displaying image slices from 3D projection data acquired via a CT system from an examination subject containing metal parts, comprising:
1.1 3D scanning of the examination subject along a system axis of the CT system by at least one X-ray detector system, wherein, by rotating the X-ray detector system about the system axis, 3D projection data is acquired from a large number of projection angles;
1.2 reconstructing first 3D image data on the basis of the acquired 3D projection data;
1.3 segmenting the reconstructed first 3D image data to produce second 3D image data, the second 3D image data containing only the first 3D image data representing the metal parts of the examination subject;
1.4 determining the 3D projection data which was affected by metal parts in the examination subject during 3D scanning;
1.5 replacing the 3D projection data determined in step 1.4. by 3D replacement data, the 3D replacement data being obtained by interpolation from the 3D projection data not affected by metal parts;
1.6 reconstructing third 3D image data on the basis of the 3D projection data containing the 3D replacement data;
1.7 generating fourth 3D image data from the third and second 3D image data, the second 3D image data being substituted into the third 3D image data;
1.8 generating first 2D image data from the generated fourth 3D image data;
1.9 segmenting the generated first 2D image data to produce second 2D image data, the second 2D image data containing only the first 2D image data representing metal parts of the examination subject;
1.10 reprojecting the first 2D image data to produce 2D reprojection data;
1.11 determining the 2D reprojection data affected by metal parts in the examination subject;
1.12 replacing the 2D reprojection data determined in step 1.11 by 2D replacement data, the 2D replacement data being obtained via a relatively more complex replacement method, relative to the interpolation of step 1.5, from the generated 2D reprojection data not affected by metal parts in the examination subject;
1.13 reconstructing third 2D image data on the basis of the 2D reprojection data containing the 2D replacement data;
1.14 generating an image slice from the third and second 2D image data, the second 2D image data being substituted into the third 2D image data; and
1.15 displaying the image slice on a display.

2. The method as claimed in claim 1, further comprising repeating, after step 1.15, steps 1.8-1.15.

3. The method as claimed in claim 1, wherein the 3D projection data is provided as a 3D sinogram.

4. The method as claimed in claim 1, wherein the 2D reprojection data is provided as a 2D sinogram.

5. The method as claimed in claim 1, wherein the 3D replacement data is acquired by interpolation between 3D projection data not affected by metal parts that is adjacent to the 3D projection data to be replaced.

6. The method as claimed in claim 5, wherein row-wise interpolation is performed in the 3D sinogram.

7. The method as claimed in claim 1, wherein the 2D replacement data is obtained by at least:
7.1 providing the 2D reprojection data as a 2D sonogram wherein, after reprojection, each pixel of the first 2D image data forms a 2D track in the 2D sinogram,
7.2 obtaining the 2D tracks in the 2D sinogram which were formed by the reprojection of pixels of the first 2D image data which represent no metal parts, and which intersect the at least one 2D track formed by the 2D reprojection data determined in step 1.11. at least at one intersection point in the 2D sinogram,
7.3 determining a minimum reprojection value on each 2D track obtained in step 7.2, and
7.4 obtaining the 2D replacement data by adding up all the minimum 2D reprojection values at all the obtained 2D tracks for the respective intersection points in the 2D sinogram.

8. The method as claimed in claim 1, wherein the fourth 3D image data is present as a stack of 2D image data layers, and the first 2D image data is generated in step 1.8 by selecting a 2D image data layer from the stack and providing the selected 2D image data layer as 2D image data.

9. The method as claimed in claim 1, wherein the fourth 3D image data is present as a stack of 2D image data layers, and that the first 2D image data is generated in step 1.8 by selecting a plurality of coordinate 2D image data layers with subsequent allocation of the image data contained in the 2D image data layers selected to the 2D image data.

10. The method as claimed in claim 1, wherein at least one of the 3D and 2D replacement data is smoothed.

11. The method as claimed in claim 10, wherein smoothing of the 3D replacement data is also performed at least compared to the unreplaced 3D projection data.

12. The method as claimed in claims 10, wherein smoothing of the 2D replacement data is also performed at least compared to the unreplaced 2D projection data.

13. The method as claimed in claim 10, wherein, in the 3D sinogram, the smoothing is carried out by averaging in the boundary region between 3D replacement data and the unreplaced 3D projection data.

14. The method as claimed in claim 10, wherein, in the 2D sinogram, the smoothing is carried out by averaging in the boundary region between 2D replacement data and unreplaced 2D reprojection data.

15. A computer system for reconstructing, analyzing and displaying CT image data, containing a program memory with computer programs, wherein, during operation, at least one of the computer programs executes the method as claimed in claim 1.

16. The method as claimed in claim 3, wherein the 3D projection data is provided as a 3D sinogram in parallel geometry.

17. The method as claimed in claim 2, wherein the 3D projection data is provided as a 3D sinogram.

18. The method as claimed in claim 17, wherein the 3D projection data is provided as a 3D sinogram in parallel geometry.

19. The method as claimed in claim 4, wherein the 2D reprojection data is provided as a 2D sinogram in parallel geometry.

20. The method as claimed in claims 11, wherein smoothing of the 2D replacement data is also performed at least compared to the unreplaced 2D projection data.

21. A computer readable medium including program segments for,
when executed on a computer device, causing the computer device to implement the method of claim 1.
